(19) United States
(12) Patent Application Publication
(10) Pub. No.: US 2015/0241879 A1
(43) Pub. Date: Aug. 27, 2015

(54) SENSOR ENHANCED FENCEROW MANAGEMENT

(71) Applicant: AGCO Corporation, Duluth, GA (US)

(72) Inventor: John Peterson, Jackson, MN (US)

(73) Assignee: AGCO Corporation, Duluth, GA (US)

(21) Appl. No.: 14/190,191

(22) Filed: Feb. 26, 2014

(51) Int. Cl. G05D 1/02

(52) U.S. Cl. CPC G05D 1/021

(57) ABSTRACT

An agricultural machine has an auto guidance system operative to direct the agricultural machine along a predetermined path. At least one sensor is attached to the agricultural machine, the at least one sensor configured to indicate the presence of an obstruction in the predetermined path. The agricultural machine further includes a processor operatively coupled to the auto guidance system. The processor receives an output from the at least one sensor indicating the presence of the obstruction in the predetermined path and sends a signal to the auto guidance system, the signal operative to cause the auto guidance system to change an operating characteristic of the agricultural machine from a first state to a second state in response to the detected obstruction.

### BACKGROUND OF THE INVENTION

1. Field of Invention

The present invention relates generally to guidance systems for agricultural machines, and more particularly to a sensor enhanced fencerow management system for the agricultural machine.

2. Description of Related Art

Various vehicles (e.g., a tractor, a combine, or a sprayer) and implements are used within an agricultural environment. The vehicle may include a guidance system to assist the operator in following a desired path. An auto-guidance system may automatically steer the agricultural machine along a predefined path (e.g., a wayline) on a farm (i.e., a working environment) divided into fields. While in each field, an operator may follow waylines a predetermined distance from boundaries. Some of the boundaries may place the agricultural machine in close proximity to potential obstacles. The potential obstacles may include, for example, a fence post leaning into the agricultural machine's path or a vehicle temporally parked in close proximity to the wayline. As the width of headers or boom arms carried by the vehicles increase, it becomes more and more difficult for the operator to judge the clearance between the tip of the header or boom and obstacles in the path.

It would be desirable to have a sensor enhanced obstacle management system to aid with the steering of the agricultural machine when encountering an obstacle while traversing a wayline.

### OVERVIEW OF THE INVENTION

In one embodiment, the invention is directed to sensor enhanced fencerow management system for an agricultural machine. The agricultural machine has an auto guidance system operative to direct the agricultural machine along a predetermined path. At least one sensor is attached to the agricultural machine, the at least one sensor configured to indicate the presence of an obstruction in the predetermined path. The agricultural machine further includes a processor operatively coupled to the auto guidance system. The processor receives an output from the at least one sensor indicating the presence of the obstruction in the predetermined path and sends a signal to the auto guidance system, the signal operative to cause the auto guidance system to change an operating characteristic of the agricultural machine from a first state to a second state in response to the detected obstruction.

As the agricultural machine traverses the wayline, sensors may collect data about an area proximate the agricultural machine, including obstacles that may be proximate the wayline. The data may be collected using systems such as, for example, radar, LIDAR, and video cameras. The data may indicate that the agricultural machine may hit the obstacle if the machine continues on the wayline. In response to data indicating the agricultural machine may hit the obstacle, a processor within the auto-guidance system may change an operating characteristic (e.g., speed, direction, or implement position) of the agricultural machine from a first state to a second state. For example, the agricultural machine may be traversing the wayline (i.e., operating in the first state) and may approach a fence post leaning into the agricultural machine's path. The processor may direct the auto guidance system to steer the agricultural machine along an alternate path (i.e., a second state). In addition, the processor may cause the machine's hydraulic system to activate to reposition an implement. Steering the agricultural machine and/or activating a hydraulic system may cause a portion of the agricultural machine to clear the obstacle. After the obstacle is cleared, the processor may direct the agricultural machine to return to the wayline and may activate the hydraulic system to return the implement to its original state (i.e., the first state).

These and other features and advantages of this invention are described in, or are apparent from, the following detailed description of various example embodiments of the systems and methods according to this invention.

### BRIEF DESCRIPTION OF THE DRAWINGS

The above mentioned and other features of this invention will become more apparent and the invention itself will be better understood by reference to the following description of embodiments of the invention taken in conjunction with the accompanying drawings, wherein:

FIG. 1 is a diagram of an operating environment for an agricultural machine;

FIG. 2 is a block diagram of a fencerow management processor; and

FIG. 3 is a flow chart of a method for providing sensor enhanced fencerow management.

The drawing figures do not limit the present invention to the specific embodiments disclosed and described herein. The drawings are not necessarily to scale, emphasis instead being placed upon clearly illustrating the principles of the preferred embodiment. Corresponding reference characters indicate corresponding parts throughout the views of the drawings.

### DETAILED DESCRIPTION OF THE PREFERRED EMBODIMENTS

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description.

An auto-guidance system may automatically steer an agricultural machine (e.g., a tractor, a combine, or a sprayer) along a predefined path (e.g., a wayline) on a farm (i.e., a working environment) divided into fields. While in each field, an operator may follow waylines a predetermined distance from boundaries. Some of the boundaries may place the agricultural machine in close proximity to potential obstacles. The potential obstacles may include, for example, a fence post or a vehicle temporally parked in close proximity to the wayline.

As the agricultural machine traverses the wayline, sensors may collect data about an area proximate the agricultural machine, including obstacles that may be proximate the wayline. The data may be collected using systems such as, for example, radar, LIDAR, and video cameras. The data may indicate that the agricultural machine may hit the obstacle if the machine continues on the wayline.

In response to data indicating the agricultural machine may hit the obstacle, a processor within the auto-guidance system may change an operating characteristic (e.g., speed, direction, or implement position) of the agricultural machine from a first state to a second state. For example, the agricultural machine may be traversing the wayline (i.e., operating in the first state) and may approach a fence post leaning into the agricultural machine's path. The processor may direct the auto guidance system to steer the agricultural machine along an alternate path (i.e., a second state). In addition, the processor may cause the machine's hydraulic system to activate to reposition an implement. Steering the agricultural machine and/or activating a hydraulic system may cause a portion of the agricultural machine to clear the obstacle. After the obstacle is cleared, the processor may direct the agricultural machine to return to the wayline and may activate the hydraulic system to return the implement to its original state (i.e., the first state).

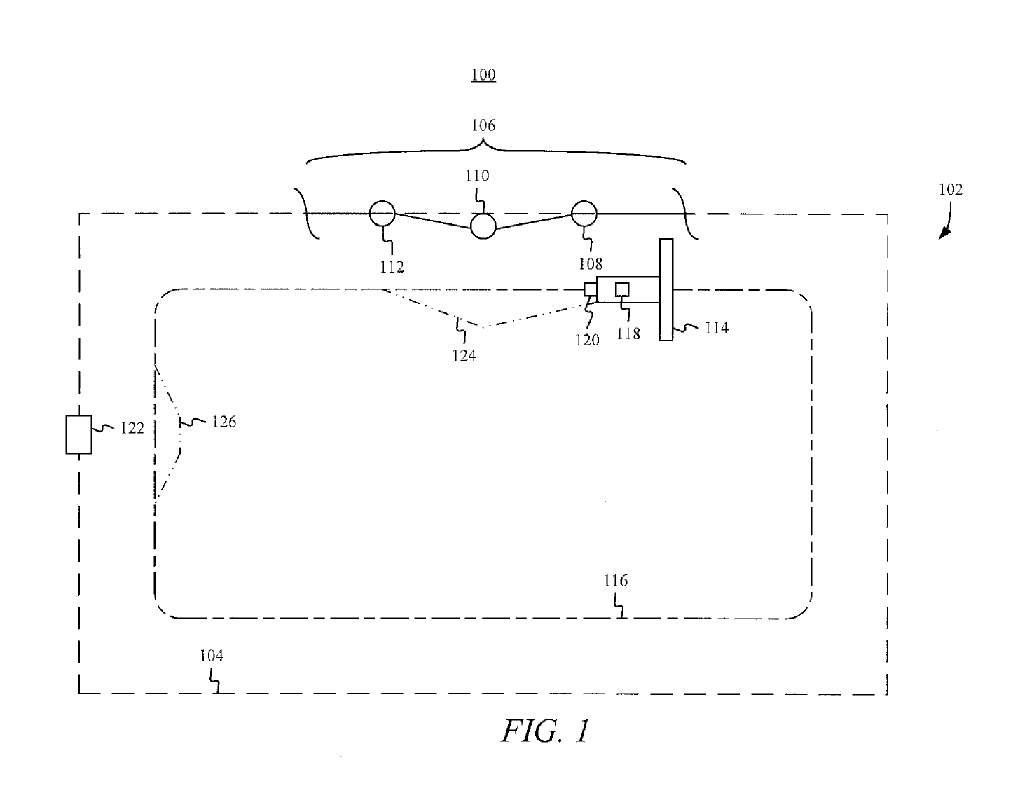

FIG. 1 is a block diagram of an operating environment 100. Operating environment 100 may comprise a field 102. Field 102 may comprise a boundary 104. Boundary 104 may be completely or partially surrounded by a fence 106. Fence 106 may comprise a first fence post 108, a second fence post 110, and a third fence post 112.

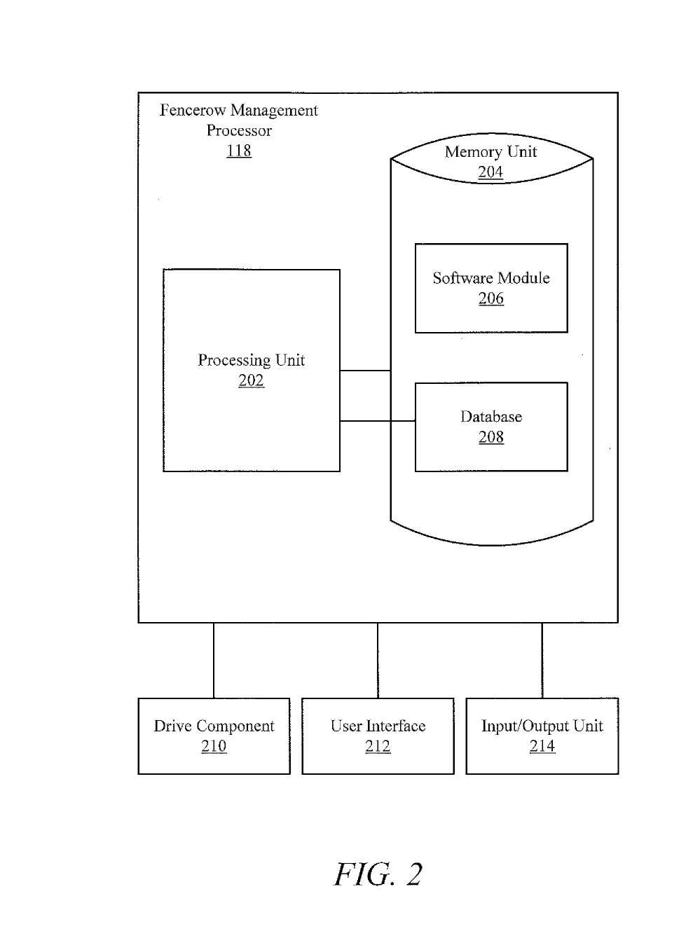

An agricultural machine 114 (e.g., a tractor, combine, or sprayer) may travel along a predetermined path (e.g., a wayline 116) under the control of an auto-guidance system. The auto guidance system may receive inputs from a fencerow management processor 118, discussed in greater detail below with respect to FIG. 2. The fencerow management processor 118 may receive inputs from a sensor 120 mounted on the agricultural machine 114. While FIG. 1 shows a single sensor 120 mounted on the agricultural machine 114, embodiments may comprise multiple sensors mounted on the agricultural machine 114 at various locations. For instance, the agricultural machine 114 may comprise sensors 120 located on an implement attached to the agricultural machine 114. An obstacle 122 (e.g., a truck) may be parked proximate boundary 104.

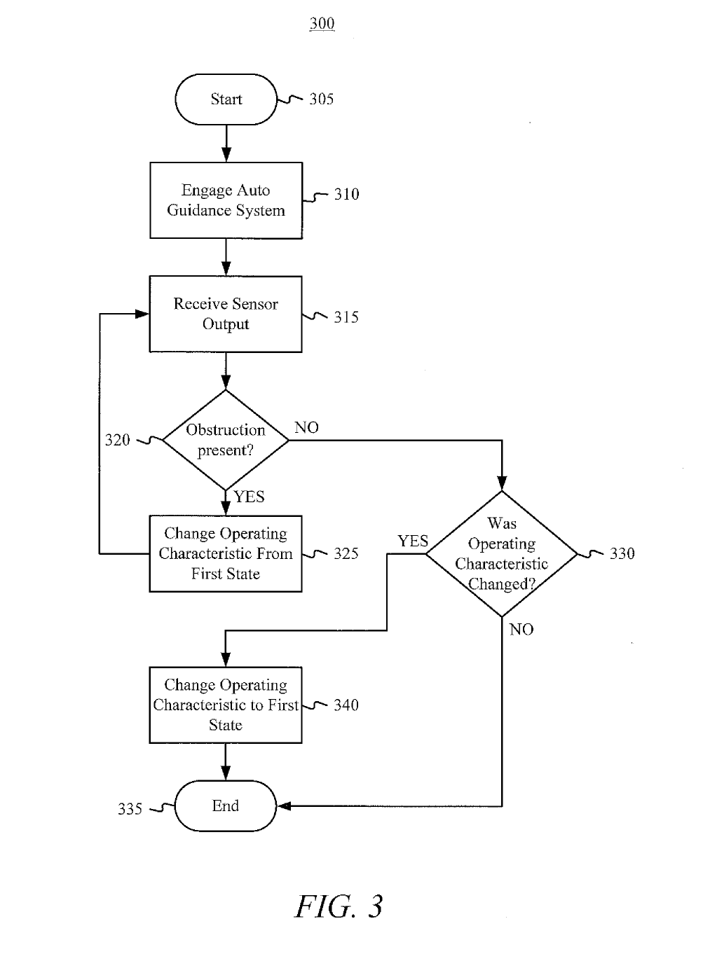

The agricultural machine 114 may encounter obstructions while traversing the wayline 116 and may deviate from the wayline 116 in response to obstructions. For example, the agricultural machine 114 may traverse a first alternate path 124 due to second fence post 110 projecting into field 102. Furthermore, the agricultural machine 114 may traverse a second alternate path 126 due to obstacle 122 being positioned proximate boundary 104. As will be discussed in greater detail below with respect to FIG. 3, the fencerow management processor 118 may detect the presence of the second fence post 110 and the obstacle 122. After detecting the second fence post 110 and the obstacle 122, the fencerow management processor 118 may change the operating characteristic of the agricultural machine 114 from the first state to the second state.

The sensor 120 may comprise, for example, a camera, a light detection and ranging (LIDAR) system, and infrared sensors. The sensor 120 may include multiple sensors. For example, the sensor 120 may include a camera and a LIDAR system. The sensor 120 may send information to the fencerow management processor 118. The fencerow management processor 118 may use the information to create a model of an area proximate the agricultural machine 114. This model may indicate the presence of obstructions in the path of the agricultural machine 114. For example, the sensor 120 may be a LIDAR system that creates a point cloud proximate the agricultural machine 114. The point cloud may represent a three dimensional representation of the area surrounding the agricultural machine 114. The fencerow management processor 118 may use the point cloud information to determine that the agricultural machine 114 may hit second fence post 110 if the agricultural machine 114 continues along the wayline 116.

FIG. 2 shows the fencerow management processor 118 in more detail. As shown in FIG. 2, the fencerow management processor 118 includes a processing unit 202 and a memory unit 204. The memory unit 204 may include a software module 206 and a database 208. The database 208 may comprise a plurality of data files. The fencerow management processor 118 also is operatively connected to a drive component 210. The drive component 210 comprises an engine and a steering linkage (not shown) for controlling movement of the agricultural machine 114. Drive component 210 includes a drive element characteristic. Example drive element characteristics include, but are not limited to, engine RPM, speed, steering direction, and turn rate. While executing on the processing unit 202, the software module 206 may perform processes for providing fencerow management, including, for example, one or more stages included in method 300 described in greater detail below with respect to FIG. 3.

In addition, a user interface 212 may be connected to the fencerow management processor 118. The user interface 212 may allow the operator to input data into the fencerow management processor 118. In addition, the user interface 212 may allow the fencerow management processor 118 to display information to the operator. For example, the user interface 212 may display a warning to the operator and allow the operator to acknowledge the warning by pressing a button.

Furthermore, the fencerow management processor 118 includes an input/output unit 214. The input/output unit 214 may allow the fencerow management processor 118 to receive inputs from the sensor 120. In addition, the input/output unit 214 may allow the fencerow management processor 118 to receive inputs from implements.

The fencerow management processor 118 (“the processor”) may be implemented using an onboard engine control unit (ECU), a personal computer, a network computer, a mainframe, or other similar microcomputer-based workstation. The processor may be located on the agricultural machine 114 or may be in a remote location. For instance, in an agricultural environment, the processor may comprise a computer located at a central location (e.g., a farm's central equipment storage and maintenance facility).

The processor 118 may comprise any computer operating environment, such as hand-held devices, multiprocessor systems, microprocessor-based or programmable sender electronic devices, minicomputers, mainframe computers, and the like. The processor may also be practiced in distributed computing environments where tasks are performed by remote processing devices. Furthermore, the processor may comprise a mobile terminal, such as a smart phone, a cellular telephone, a cellular telephone utilizing wireless application protocol (WAP), personal digital assistant (PDA), intelligent pager, portable computer, a hand held computer, or a wireless fidelity (Wi-Fi) access point. The aforementioned systems and devices are examples and the processor may comprise other systems or devices.

FIG. 3 is a flow chart setting forth the general stages involved in a method 300 for fencerow management. Method 300 may be implemented using, for example, the fencerow management processor 118 as described in more detail above. Ways to implement the stages of method 300 will be described in greater detail below.

Method 300 may begin at starting block 305 and proceed to stage 310 where an auto guidance system may be engaged. The auto guidance system may be engaged by an operator. As will be described below, the auto guidance system may send and receive information from the fencerow management processor 118. For example, the operator may drive the agricultural machine 114 to field 102. Once at field 102, the operator may engage the auto guidance system so that the agricultural machine 114 follows the wayline 116.

For example, the wayline 116 may be a wayline outlining a path proximate field 102's perimeter. The auto guidance system may follow the wayline 116 such that the agricultural machine 114 travels a preset distance (e.g., six inches) from boundary 104. As the agricultural machine 114 follows the wayline 116 the auto guidance system and the fencerow management processor 118 may send and receive information between each other. The transfer of information may allow the agricultural machine 114 to traverse the wayline 116 while staying the preset distance from boundary 104 and any obstruction (e.g., second fence post 110 and obstacle 122) located proximate the wayline 116.

From stage 310 where the auto guidance system is engaged, method 300 may proceed to stage 315 where the fencerow management processor 118 may receive a sensor output from the sensor 120. The sensor output may comprise data that the fencerow management processor 118 can process to determine if an obstacle is within the path of the agricultural machine 114. The sensor output may comprise, but is not limited to, a video stream, images from a camera, or point cloud data from a LIDAR system.

From stage 315 where the fencerow management processor 118 receives the sensor output, method 300 may proceed to decision block 320 where the fencerow management processor 118 may determine if there is an obstruction present along a predetermined path (e.g., the wayline 116). For example, as the agricultural machine 114 progresses along the wayline 116, the fencerow management processor 118 may receive point cloud information from the sensor 120. The fencerow management processor 118 may use the point cloud information and may determine that second fence post 110 is within the path of the agricultural machine 114.

For example, images may be received from the sensor 120. The fencerow management processor 118 may use image analysis software to analyze the images and create a three dimensional model of the area surrounding the agricultural machine 114. The three dimensional model may indicate the presents of an obstruction (e.g., second fence post 110). In addition, the three dimensional model may allow the fencerow management processor 118 to determine a size of the obstruction. For example, the three dimensional model may allow the fencerow management processor 118 to determine that second fence post 110 is four feet tall.

Also, the sensor 120 may be a LIDAR system that may create a point cloud proximate the agricultural machine 114. The point cloud may be used by the fencerow management processor 118 to create a three dimensional representation of the area surrounding the agricultural machine 114. The fencerow management processor 118 may use the point cloud information to detect the presence of the obstruction.

From decision block 320 where the fencerow management processor 118 determines the obstruction is present, method 300 may proceed to stage 325 where an operating characteristic may be changed from a first state to a second state. For example, as the agricultural machine 114 is traversing the wayline 116, the agricultural machine 114 may be operating in the first state (i.e., at a constant speed and direction). As the agricultural machine 114 approaches obstacle 122, the fencerow management processor 118 may detect obstacle 122. In response to detecting obstacle 122, the fencerow management processor 118 may cause the agricultural machine 114 to operate in the second state. In other words, the fencerow management processor 118 may cause the auto guidance system to steer the agricultural machine 114 long second alternate path 126 to avoid obstacle 122. In addition, as the agricultural machine 114 approaches second fence post 110, the fencerow management processor 118 may cause the auto guidance system to steer the agricultural machine 114 along first alternate path 124 to avoid second fence post 110.

The fencerow management processor 118 may change multiple operating characteristics. For instance, second fence post 110 may be short (e.g., four feet tall). As the agricultural machine 114 approaches second fence post 110, the fencerow management processor 118 may cause the auto guidance system to steer the agricultural machine 114 along first alternate path 124 and raise an implement (e.g., a sprayer boom) attached to the agricultural machine 114. In addition to steering the agricultural machine 114 or manipulating an implement, the output may also cause the fencerow management processor 118 to send a warning message to the operator. For instance the fencerow management processor 118 may cause an alarm to sound to alert the operator of the obstruction.

In stage 325, the fencerow management processor 118 may change an operating characteristic of the agricultural machine 114 (e.g., a drive element characteristic) and not an operating characteristic of the implement (e.g., an implement operating characteristic) attached to the agricultural machine 114. For example, the fencerow management processor 118 may detect second fence post 110 and may cause the agricultural machine 114 to deviate from the wayline 116 (i.e., change the drive element characteristic). For instance, after detecting second fence post 110, the fencerow management processor 118 may cause agricultural machine to deviate from the wayline 116 so it remains a predetermined distance from second fence post 110. While the fencerow management processor 118 causes the agricultural machine 114 to deviate course (i.e., change the drive element characteristic), it may not alter operating characteristics of implements attached to it.

The fencerow management processor 118 may change an operating characteristic of the implement (e.g., an implement operating characteristic) attached to the agricultural machine 114 and not the operating characteristic of the agricultural machine 114 (e.g., a drive element characteristic). For example, the fencerow management processor 118 may detect second fence post 110 and may raise the implement (i.e., change the implement operating characteristic) attached to the agricultural machine 114 while not deviating from the wayline 116 (i.e., not changing the drive element characteristic). For instance, the fencerow management processor 118 may detect second fence post 110 and raise a boom to clear second fence post 110 while the agricultural machine 114 continues along the wayline 116.

During stage 325, the fencerow management processor 118 may slow the speed of the agricultural machine 114. The reduction in speed may allow the fencerow management processor 118 to select an additional operating characteristic to be changed. For instance, as the agricultural machine 114 approaches obstacle 122, the fencerow management processor 118 may slow the speed of the agricultural machine 114. For example, obstacle 122 may be large or may quickly appear in the path of the agricultural machine 114. As such, the agricultural machine 114 may need to slow its speed to avoid a collision. The speed of the agricultural machine 114 may be slowed incrementally as agricultural machine approaches obstacle 122. In addition, the fencerow management processor 118 may bring the agricultural machine 114 to a complete stop.

After changing the operating characteristic in stage 325, method 300 may proceed to stage 315 where the fencerow management processor 118 may receive sensor outputs as described above. After receiving the sensor outputs in stage 315, method 300 may proceed to decision block 320 where the fencerow management processor 118 may determine if the obstruction is still present. Stages 315 through 325 may be repeated as necessary to clear the obstruction. For example, the fencerow management processor 118 may reduce the speed of the agricultural machine 114 during a first pass through stage 325. During a second pass through stage 325, the fencerow management processor 118 may steer the agricultural machine 114 and/or continue reducing the speed of the agricultural machine 114. As stages 315 through 325 are repeated, the fencerow management processor 118 may bring agricultural machine 114 to a stop. During the time the agricultural machine 114 is stopped, the fencerow management processor 118 may continue cycling through stages 315 through 325 to determine an appropriate operating parameter to change.

If at decision block 320, the fencerow management processor 118 determines, however, that the obstruction is not present, method 300 may proceed to decision block 330 where the fencerow management processor 118 may determine if an operating characteristic was changed from the first state to the second state. If the operating characteristic was not changed from the first state to the second state, method 300 may terminate at termination block 335.

If at decision block 330, the fencerow management processor 118 determined the operating characteristic was changed, method 300 may proceed to stage 340 where the fencerow management processor 118 may change the operating characteristic back to the first state. For example, in stage 325, the fencerow management processor 118 may have caused the auto guidance system to steer the agricultural machine 114 along first alternate path 124 and raise a boom to avoid second fence post 110. In stage 340, the fencerow management processor 118 may direct auto guidance system to steer the agricultural machine 114 back to the wayline 116 and may lower the boom back to its original position. After changing the operating characteristic back to the first state, method 300 may terminate at termination block 335. Method 300 may repeat at regular intervals. For example, method 300 may repeat every 1 second, 10 seconds, 30 seconds, etc.

An embodiment may comprise a method for enhanced fencerow management. First an auto guidance system may be engaged. The auto guidance system may be configured to direct an agricultural machine along a predetermined path. A sensor output may be received. The sensor output may be configured to indicate the presence of an obstruction in the predetermined path. After receiving the sensor output indicating the presence of an obstruction in the predetermined path, an operating characteristic of the agricultural machine may be changed from a first state to a second state.

Another embodiment may comprise a memory and a processor operatively connected to the memory. The processor may be operative to engage an auto guidance system. The auto guidance system may be configured to direct an agricultural machine along a predetermined path. The processor may be further operative to receive a sensor output. The sensor output may be configured to indicate the presence of an obstruction in the predetermined path. The processor also may be configured to change an operating characteristic of the agricultural machine from a first state to a second state, after receiving the sensor output indicating the presence of an obstruction in the predetermined path.

Yet another embodiment may comprise an agricultural machine, a sensor, and a processor coupled to an auto guidance system. The auto guidance system may be operative to direct the agricultural machine along a predetermined path. The sensor may be attached to the agricultural machine and operative to indicate the presence of an obstruction in the predetermined path. The processor may be operative to engage the auto guidance system, receive an output from the sensor indicating the presence of the obstruction in the predetermined path, and send a signal to the auto guidance system. The signal may be operative to cause the auto guidance system to change an operating characteristic of the agricultural machine from a first state to a second state.

While this invention has been described in conjunction with the specific embodiments described above, it is evident that many alternatives, combinations, modifications and variations are apparent to those skilled in the art. Accordingly, the preferred embodiments of this invention, as set forth above are intended to be illustrative only, and not in a limiting sense. Various changes can be made without departing from the spirit and scope of this invention.

What is claimed is:

1. A method of operating an agricultural machine comprising:
engaging an auto guidance system, the auto guidance system configured to direct an agricultural machine along a predetermined path;
receiving a sensor output configured to indicate the presence of an obstruction in the predetermined path; and
changing an operating characteristic of the agricultural machine from a first state to a second state based upon the sensor output.

2. The method of claim 1, wherein changing the operating characteristic of the agricultural machine comprises deviating from the predetermined path.

3. The method of claim 2, wherein deviating from the predetermined path comprises:
calculating a size of the obstruction; and
deviating from the predetermined path a predetermined distance based upon the calculated size of the obstruction.

4. The method of claim 1, wherein the agricultural machine comprises a drive component comprising a drive element characteristic and an implement comprising an implement operating characteristic, wherein changing the operating characteristic of the agricultural machine comprises changing the implement operating characteristic and not altering the drive element characteristic.

5. The method of claim 1, wherein changing the operating characteristic of the agricultural machine comprises raising a boom.

6. The method of claim 1, further comprising changing the operating characteristic from the second state to the first state.

7. The method of claim 6, wherein changing the operating characteristic from the second state to the first state comprises returning to the predetermined path.

8. The method of claim 6, wherein changing the operating characteristic from the second state to the first state comprises lowering a boom.

9. An apparatus for operating an agricultural machine comprising:
a memory; and
a processor coupled to the memory, the processor operative to:
engage an auto guidance system, the auto guidance system configured to direct the agricultural machine along a predetermined path;
receive a sensor output configured to detect the presence of an obstruction in the predetermined path; and
change an operating characteristic of the agricultural machine from a first state to a second state in response to the detected obstruction.

10. The apparatus of claim 9, wherein the processor operative to change the operating characteristic of the agricultural machine comprises the processor operative to deviate from the predetermined path.

11. The apparatus of claim 10, wherein the processor operative to deviate from the predetermined path comprises the processor operative to:
calculate a size of the obstruction; and
deviate from the predetermined path a predetermined distance based upon the calculated size of the obstruction.

12. The apparatus of claim 9, wherein the processor operative to change the operating characteristic of the agricultural machine comprises the processor operative to change a speed of the agricultural machine.

13. The apparatus of claim 9, wherein the processor operative to change the operating characteristic of the agricultural machine comprises the processor operative to raise a boom.

14. The apparatus of claim 9, wherein the processor is further operative to return to the operating characteristic to the first state.

15. The apparatus of claim 14, wherein the processor operative to return the operating characteristic to the first state comprises the processor operative to return to the predetermined path.

16. The apparatus of claim 9, wherein the processor operative to return the operating characteristic to the first state comprises the processor operative to lower a boom.

17. An agricultural machine comprising:
an auto guidance system operative to direct the agricultural machine along a predetermined path;
at least one sensor attached to the agricultural machine, the at least one sensor configured to detect the presence of an obstruction in the predetermined path; and
a processor operatively coupled to the auto guidance system, the processor operative to:
engage the auto guidance system, the auto guidance system configured to direct the agricultural machine along the predetermined path,
receive an output from the at least one sensor indicating the presence of the obstruction in the predetermined path, and
send a signal to the auto guidance system, the signal operative to cause the auto guidance system to change an operating characteristic of the agricultural machine from a first state to a second state in response to the detection of the obstruction.

18. The apparatus of claim 17, wherein the at least one sensor comprises at least one of the following: a radar system, a sonar system, and a light detection and ranging (LIDAR) system.

19. The apparatus of claim 17, wherein the processor operative to send the signal to the auto guidance system to change the operating characteristic of the agricultural machine comprises the processor operative to change both a speed and a direction of the agricultural machine.

20. The apparatus of claim 17, wherein;
the at least one sensor operative to indicate the presence of the obstruction in the predetermined path comprises the sensor operative to detect a size of the obstruction;
the processor operative to send the signal operative to cause the auto guidance system to change the operating characteristic of the agricultural machine comprises the processor further operative to:
determine an alternate path based on the size of the obstruction; and
engage the auto guidance system to follow the alternate path based upon the calculated size of the obstruction.
